(19) United States
(12) Patent Application Publication
(10) Pub. No.: US 2026/0017219 A1
(43) Pub. Date: Jan. 15, 2026

(54) ARITHMETIC OPERATOR

(71) Applicant: Fujitsu Limited, Kawasaki-shi (JP)

(72) Inventor: Yosuke NAKAMURA, Kawasaki (JP)

(73) Assignee: Fujitsu Limited, Kawasaki-shi (JP)

(21) Appl. No.: 19/243,253

(22) Filed: Jun. 19, 2025

(30) Foreign Application Priority Data
Jul. 9, 2024 (JP) 2024-110510

(51) Int. Cl. G06F 13/38

(52) U.S. Cl. CPC G06F 13/38; G06F 2213/40

(57) ABSTRACT

An arithmetic operator includes: multiple arithmetic elements each serving as a programmable circuit capable of programming a logical function; and a data bus that connects two or more of the multiple arithmetic elements and that transmits transmission data. The transmission data includes first data used in one of the two or more arithmetic elements and second data used to reconfigure a logical function of any one of the two or more arithmetic elements, the transmission data destined for each of the two or more arithmetic elements on the same data bus is collectively transmitted on the same data bus at a cycle different with each of the two or more arithmetic elements, and each arithmetic elements receives the first data and the second data for own arithmetic element by extracting the transmission data destined for the own arithmetic element at a cycle associated with the own arithmetic element.

### CROSS-REFERENCE TO RELATED APPLICATION

This application is based upon and claims the benefit of priority of the prior Japanese Patent application No. 2024-110510, filed on Jul. 9, 2024, the entire contents of which are incorporated herein by reference.

### FIELD

The embodiment discussed herein relates to an arithmetic operator.

### BACKGROUND

For example, a DNN (Deep Neural Network) frequently uses matrix product calculation. For the above, a system has been known which is provided with, as a hardware configuration, an arithmetic operator (accelerator) that accelerates matrix product calculation. One of the known accelerators is a matrix arithmetic operator having a two-dimensional systolic array configuration. In a systolic array configuration, multiple PEs (Processing Elements) forms a PE group that arranges therein the multiple PEs in a two-dimensional grid pattern.

Also a programmable logic device has been known which includes multiple programmable circuits and makes these blocks connectable to one another by programmable connecting means (see, for example, Patent Documents 1 to 3). It has been also known to configure a systolic array with programmable circuits.

FIG. 12 is a diagram illustrating a configuration of a typical systolic array.

In the systolic array illustrated in FIG. 12, multiple PEs arranged in a two-dimensional grid pattern are connected by data buses DB. The data buses DB include buses that cascade the PEs in a row direction and buses that cascade the PEs in a column direction. The data buses DB transmit data to be used by the respective PEs to perform arithmetic operations (normal calculation). In FIG. 12, arrows indicated by the data buses DB indicate the flow of data.

Each PE receives data (result of arithmetic operation) from a neighboring upstream PE via the data bus DB and performs an arithmetic operation. The result of the arithmetic operation is passed to the neighboring downstream PE via the data bus DB.

Further, in the typical systolic array configuration illustrated in FIG. 12, all PEs are cascaded by one configuration path CP. The configuration path CP transmits configuration information for setting the circuitry of the respective PE that are programmable circuits. In each PE, reconfiguration of the circuitry is carried out on the basis of the configuration information received via the configuration path CP, and consequently the operation (contents of arithmetic operation) of the PE is switched appropriately. In some cases, the PEs perform different operations (arithmetic operations).

In general, comparing a data bus DB with the configuration path CP, the data bus DB is thicker than the configuration path CP.

For example, a related art is disclosed in US Patent Application Publication No. 2023/0014412 (Patent Document 1), Japanese Laid-Open Patent Publication No. 01-080128 (Patent Document 2), and Japanese National Publication of International patent application Ser. No. 10/505,993 (Patent Document 3).

### SUMMARY

According to an aspect of the embodiments, an arithmetic operator includes: a plurality of arithmetic elements each serving as a programmable circuit capable of programming a logical function; and a data bus that connects two or more of the plurality of arithmetic elements and that transmits transmission data, wherein the transmission data includes first data to be used in any one of the two or more arithmetic elements and second data to be used to reconfigure a logical function of any one of the two or more arithmetic elements, the transmission data destined for each of the two or more arithmetic elements on the same data bus is collectively transmitted on the same data bus at a cycle different with each of the two or more arithmetic elements, and each of the two or more arithmetic elements includes a reception processor that selectively receives the first data and the second data destined for own arithmetic element by extracting the transmission data destined for the own arithmetic element at a cycle associated with the own arithmetic element from the data bus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a PE group of an accelerator according to an example of the first embodiment;

FIG. 2 is a diagram illustrating a method for transmitting transmission data in the accelerator of the example of the first embodiment;

FIG. 3 is a diagram illustrating a format of the transmission data forwarded in the accelerator of the example of the first embodiment;

FIG. 4 is a diagram illustrating transmitting of the transmission data through multiple data buses in the accelerator of the example of the first embodiment;

FIG. 5 is a diagram illustrating the configuration of a reception processor provided to each PE of the accelerator of the example of the first embodiment;

FIG. 6 is a diagram illustrating an effect brought by a method for transmitting the transmission data in the accelerator of the example of the first embodiment;

FIG. 7 is a diagram illustrating a method for transmitting transmission data in the accelerator of the example of the second embodiment;

FIG. 8 is a diagram illustrating a data configuration that achieves a data aggregation forwarded in the accelerator of the example of the second embodiment;

FIG. 9 is a diagram illustrating transmitting of the transmission data through multiple data buses in the accelerator of the example of the second embodiment;

FIG. 10 is a diagram illustrating the configuration of a reception processor provided to each PE of the accelerator of the example of the second embodiment;

FIG. 11 is a diagram illustrating an effect brought by method for transmitting transmission data in the accelerator of the example of the second embodiment;

FIG. 12 is a diagram illustrating a configuration of a typical systolic array; and

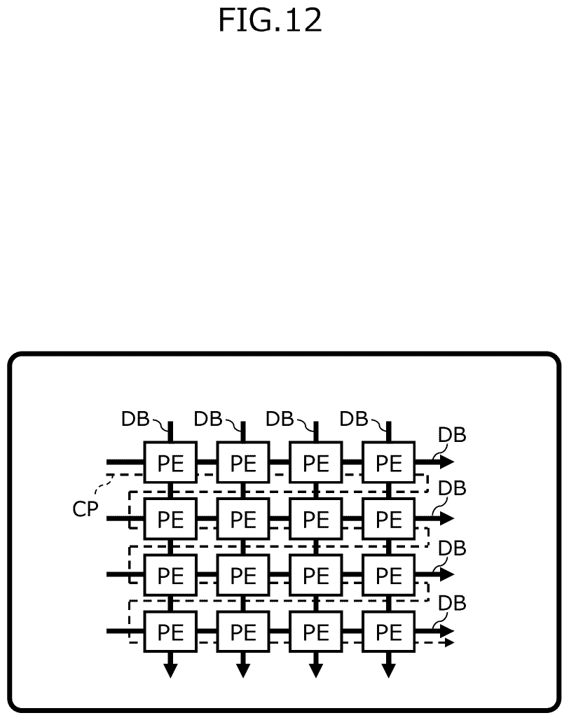

FIG. 13 is a diagram illustrating using states of a data bus and a configuration path of a typical systolic array.

### DESCRIPTION OF EMBODIMENT(S)

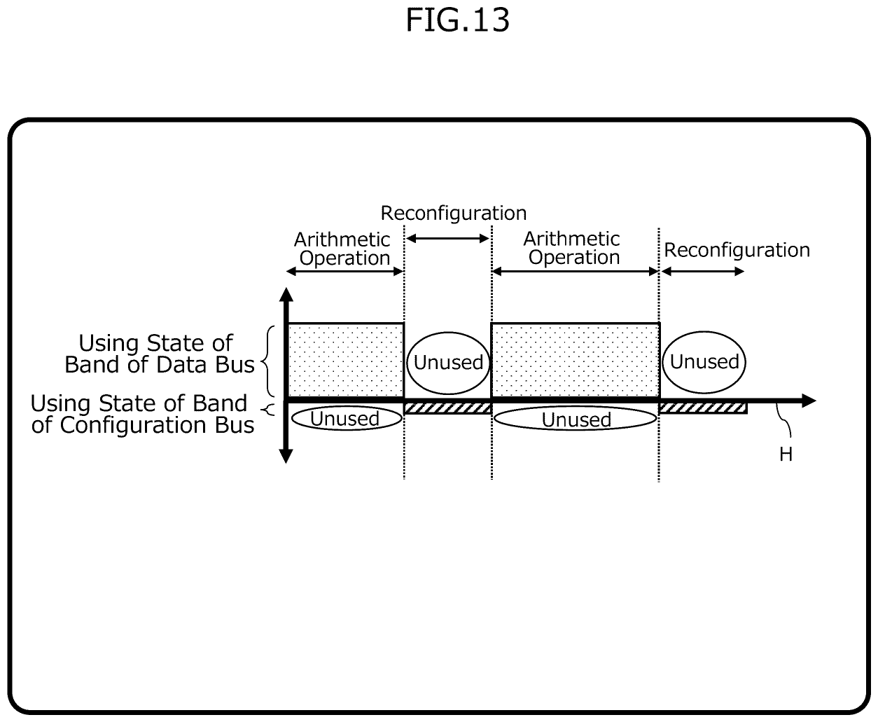

FIG. 13 is a diagram illustrating using states of a data bus and a configuration path in a typical systolic array. FIG. 13 illustrates an example in which an arithmetic operation and the reconfiguration of the circuitry are repeatedly performed and the calculation time and the reconfiguration time are alternately generated.

In FIG. 13, the upper side of the reference line H represents the using state of the data bus DB, and the lower side of the reference line H represents the using state of the configuration path CP. The right direction represents the elapsed time. A region with the dot-pattern indicates a state where the data bus DB is being used to transmit data, and the data bus DB is used in the calculation time. A region with oblique lines indicates a state where the configuration path CP is being used to transmit configuration information, and the configuration path CP is used at the reconfiguration time.

As illustrated in FIG. 13, in the typical systolic array, the configuration path CP is unused in the calculation time, and the data bus DB is unused in the reconfiguration time, which is inefficiently.

In a systolic array, the total time that arithmetic operations take can be represented by the sum of the operation time and the reconfiguration time. When the scale of a systolic array is increased by increasing the number of PEs constituting the systolic array, the calculation time would be shortened but the reconstruction time would be increased. Therefore, in the typical systolic array, efficient transmission of, in particular, the reconfiguration information for reconfiguration to shorten the time for reconfiguration is demanded.

Hereinafter, description will now be made in relation to an arithmetic operator according to embodiments with reference to the accompanying drawings. However, the following embodiments are merely illustrative and are not intended to exclude the application of various modifications and techniques not explicitly described in the embodiments. Namely, the present embodiment can be variously modified and implemented without departing from the scope thereof. Further, each of the drawings can include additional functions not illustrated therein to the elements illustrated in the drawing.

### Description of First Embodiment

### Configuration:

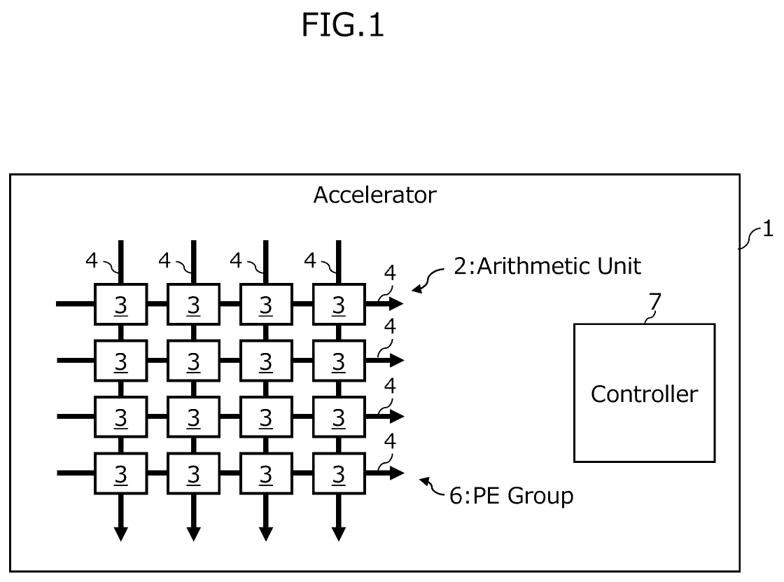

FIG. 1 is a diagram illustrating a configuration of a PE group 6 of an accelerator 1 according to an example of the first embodiment.

The accelerator 1 is a hardware accelerator having a function of performing an arithmetic operation, and is exemplified by an arithmetic operator connected to a non-illustrated host computer. The accelerator 1 may perform, for example, a matrix arithmetic operation and may perform an arithmetic operation other than a matrix product.

The host computer 1 may be, for example, a HPC (High Performance Computing), or a personal computer, and various modifications can be suggested.

The host computer causes the accelerator 1 to perform an arithmetic operation by issuing a command instructing the accelerator 1 to execute the arithmetic operation. The host computer receives the result of the arithmetic operation from the accelerator 1.

The host computer transmits, to the accelerator 1, data (which may be referred to as normal calculation data) to be used for executing an arithmetic operation (normal calculation) along with a command for instructing execution of the arithmetic operation. The normal calculation data is an example of first data to be used in any one of two or more PEs 3 (arithmetic elements).

In addition, the host computer may cause the accelerator 1 to execute the circuitry reconfiguration of the accelerator 1 as needed. For example, the host computer sends a command for executing circuitry reconfiguration to the accelerator 1. In order to execute circuitry reconfiguration of the accelerator 1, the host computer may transmit information (which may be referred to as reconfiguration data) for setting the circuitry configuration of the respective PEs 3 that are programmable circuits along with the command. The reconfiguration data is an example of second data to be used to reconfigure the logical function of any one of two or more PEs 3 (arithmetic elements).

The accelerator 1 includes the controller 7 and the arithmetic unit 2 as illustrated in FIG. 1.

The controller 7 controls execution of an arithmetic operation of a matrix product by the arithmetic unit 2. The controller 7 receives a command for executing an arithmetic operation, for example, from the host computer and controls the operation of the arithmetic unit 2. Upon receipt of a command for circuitry reconfiguration from the host computer, the controller 7 transmits information (reconfiguration data) for setting the circuitry configuration of a target PE 3 serving as a programmable circuit in the PE group 6.

The arithmetic unit 2 executes an arithmetic operation in obedience to the command issued by the host computer. The arithmetic unit 2 has a two-dimensional systolic array configuration. The arithmetic unit 2 may, for example, execute a matrix product calculation. The arithmetic unit 2 includes the PE group 6 consisting of multiple PEs 3. The arithmetic unit 2 may include one or more memories that retains data before being inputted into the PE group 6 and a result of an arithmetic operation performed by the PE group 6. A PE 3 is an example of an arithmetic element configured as a programmable circuit capable of programming a logical function. The circuitry of the PE 3 is set on the basis of reconfiguration data.

The accelerator 1 illustrated in FIG. 1 is an arithmetic operator having a systolic array configuration, and in the PE group 6, multiple PEs 3 are arranged in a two-dimensional grid pattern. In the example illustrated in FIG. 1, the accelerator 1 has a two-dimensional systolic array configuration consisting of 16 PEs 3 arranged in four rows and four columns.

In the systolic array (PE group 6) illustrated in FIG. 1, multiple PEs 3 arranged in a two-dimensional grid pattern are connected by data buses 4. The data buses 4 are multiple (four in example of FIG. 1) buses cascading the PEs 3 in the row direction (the left-right direction of FIG. 1) and multiple (four in example of FIG. 1) of buses cascading the PEs 3 in the column direction (the vertical direction of FIG. 1).

The data buses 4 transmit normal calculation data that the respective PEs 3 use to execute arithmetic operations (normal calculations). Each PE 3 receives data (result of an arithmetic operation) from the neighboring upstream PE 3 through the data bus 4, and executes an arithmetic operation. The result (result of an arithmetic operation) of the arithmetic operation executed in the PE 3 is passed to the neighboring downstream PE 3 through the data bus 4.

Further, in the present accelerator 1, the data buses 4 also transmit reconfiguration data for setting the circuit configuration of the respective PEs 3 that are programmable circuits. On the data bus 4, reconfiguration data destined for the PEs 3 (transmission destinations) arranged on the same data bus 4 is transmitted.

As described above, in the present accelerator 1, each data bus 4 has an additional function as a configuration path that has been included in a typical systolic array to a function of transmitting normal calculation data. The data buses 4 are used both in transmission of normal calculation data and transmission of the reconfiguration data.

Hereinafter, when the normal calculation data and the reconfiguration configuration that are transmitted through the data buses 4 are not distinguished from each other, these data are referred to as transmission data. The control for causing the data buses 4 to transmit transmission data (normal calculation data and the reconfiguration data) may be performed by, for example, the controller 7, or may be performed by another non-illustrated controller, and various modifications can be suggested.

In FIG. 1, the arrows indicated by the data buses 4 indicate the flows of transmission data (normal calculation data, reconstruction data).

In each PE 3, reconfiguration of the circuitry therein is carried out on the basis of the reconfiguration data received via the data bus 4, and consequently the operation (contents of arithmetic operation) of the PE 3 is switched appropriately. In some cases, the PEs 3 perform different operations (arithmetic operations).

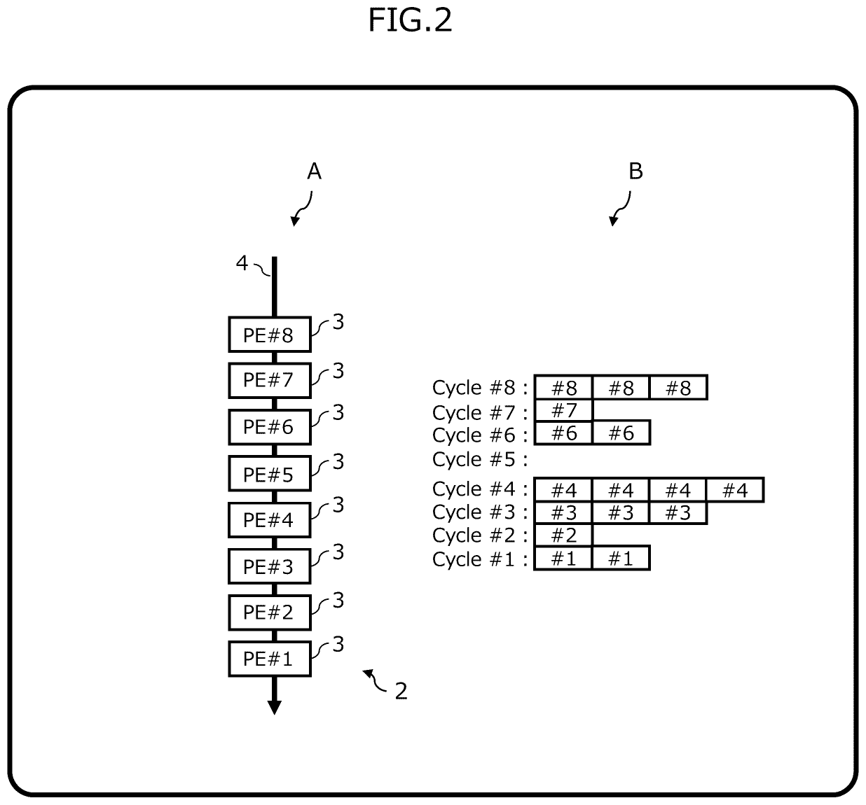

FIG. 2 is a diagram illustrating a method of transmitting the transmission data in the accelerator 1 of the example of the first embodiment.

In FIG. 2, the reference sign A indicates multiple PEs 3 constituting one of multiple columns included in the PE group 6. FIG. 2 illustrates an example that transmits transmission data to eight PEs 3 of PE #1 to PE #8 connected to the bus 4. In the expressions of the PE #1 to #8, #1 to #8 are identification information that specifies the respective PEs 3. This identification information may be referred to as PE numbers. In addition, the reference sign B illustrates an transmission data transmitted to the data bus 4 indicated by reference sign A.

In the accelerator 1 of the first embodiment, the data bus 4 transmits the transmission data therethrough in a time-slot scheme for each PE 3. Specifically, transmission data destined for the multiple PEs 3 on the same data bus 4 are collected for each destination (each PE 3) and transmission data destined for the same PE 3 are transmitted in a single cycle.

That is, the transmission data destined for each of the two or more PEs 3 on the same data bus 4 is collectively transmitted on the same data bus 4 at a cycle different with each of the two or more PEs 3.

In the example illustrated in FIG. 2, in cycle #1, two pieces of transmission data destined for the PE #1 are transmitted, and in cycle #2, one piece of the transmission data destined for the PE #2 is transmitted. In cycle #3, three pieces of transmission data destined for the PE #3 are transmitted, and in cycle #4, four pieces of the transmission data destined for the PE #4 is transmitted. Also, in cycle #6, two pieces of transmission data destined for the PE #6 are transmitted, and in cycle #7, one piece of the transmission data destined for the PE #7 is transmitted. Furthermore, in cycle #8, three pieces of transmission data destined for the PE #8 are transmitted. Since there is no transmission data destined for the PE #5, transmission data is not transmitted in cycle #5.

When the data aggregation illustrated in reference sign B of FIG. 2 is transmitted through the data bus 4, the bus occupancy period is eight cycles.

In the accelerator 1 according to the first embodiment, the procedure for data transmission (e.g., destination confirmation or negotiation) may be performed in each cycle, and does not have to be performed for each piece of the transmission data. Therefore, in example illustrated in FIG. 2, the 16 pieces of the transmission data to PE #1 to PE #8 are transmitted in a transmission procedure for eight cycles.

The same process is carried out for each column. In addition, the same process is carried out for each of multiple rows included in the PE group 6.

As described above, in the accelerator 1 of the first embodiment, transmission data addressed to the multiple PEs 3 arranged on the data bus 4 are transmitted through the same data bus 4. As a result, multiple pieces of transmission data destined for different PEs 3 are transmitted through one data bus 4.

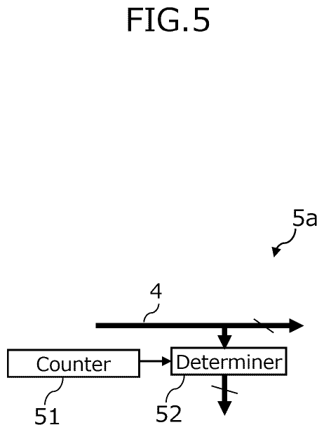

For this purpose, in the accelerator 1 of the first embodiment, each PE 3 is provided with a reception processor 5a (see FIG. 5) that receives transmission data that the same PE 3 is to process from the data bus 4.

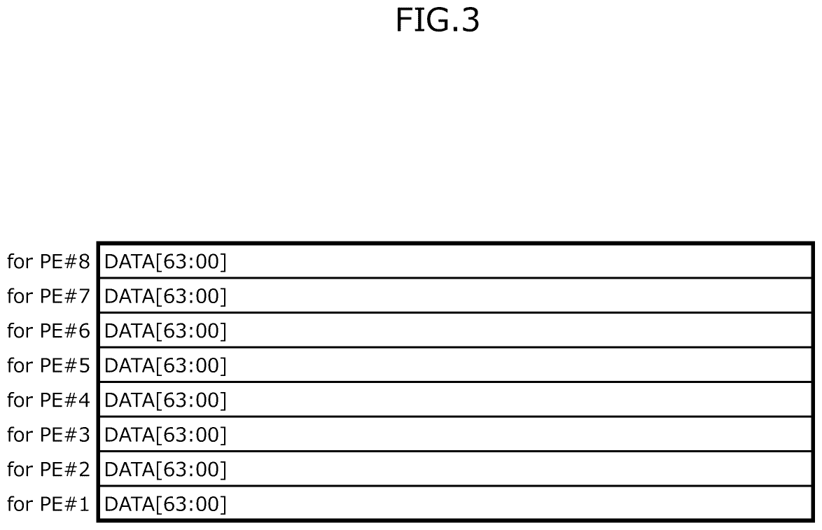

FIG. 3 is a diagram illustrating a format of the transmission data forwarded in the accelerator 1 of the example of the first embodiment.

The transmission data has format as a data storing region. In the example of FIG. 3, eight data storing regions (transmission data) are illustrated in association with the PE #1 to the PE #8, respectively. The data units are stored in the respective data storing regions. A data unit may be, for example, a 64-bit data that ranges from the 0th to 63rd bits. In example illustrated in FIG. 3, the data unit is represented by DATA[63:00].

These data units are data that are processed by the respective PEs 3. The data unit included in the normal calculation data is used for an arithmetic operation to be executed by the PE 3. The data unit included in the reconfiguration data is used for reconfiguration of the PE 3. In the transmission data illustrated in FIG. 3, the data unit may have a 64-bit bus width.

If the data amount that the PE 3 needs matches the bus width of the data bus 4, the transmission data can be transmitted the most efficiently.

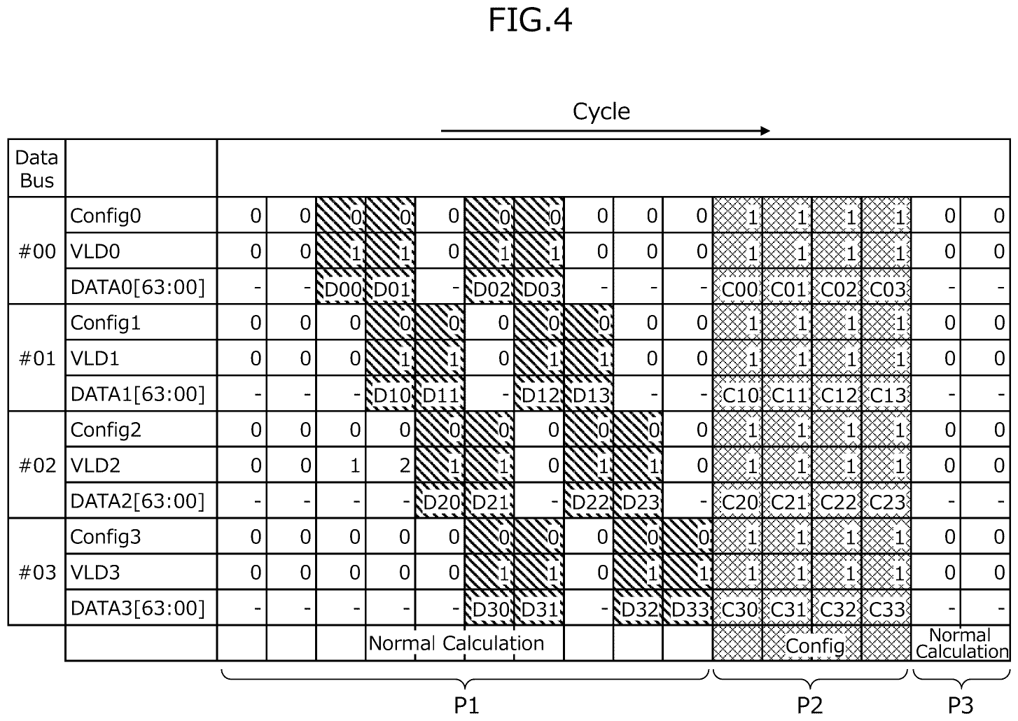

FIG. 4 is a diagram illustrating transmitting of the transmission data through multiple data buses 4 in the accelerator 1 of the example of the first embodiment.

FIG. 4 illustrates multiple pieces of transmission data transmitted in four respective neighboring data buses #00 to #03 in the accelerator 1. In addition, in FIG. 4, the right direction of the drawing indicates the direction of passage of time and one square corresponds to one cycle (transmitting cycle). In FIG. 4, multiple pieces of transmission data arranged vertically in the drawing are transmitted in the same cycle.

Each of multiple PEs 3 on the data buses #00 to #03 uses the data unit of the normal calculation data for an arithmetic operation. At each cycle, the result of the arithmetic operation of each PE 3 is passed to another PE 3 on a neighboring data bus 4, which sequentially executes a process using the result. For example, the result of an arithmetic operation performed by a particular PE 3 on the data bus #00 is processed in neighboring PE 3 on the data bus #01 neighboring this particular PE 3 in the next cycle.

In the accelerator 1 of the first embodiment, the transmission data includes an arithmetic/reconfiguration selecting signal, a VLD signal, and a data unit.

A data unit contains data to be processed by a PE 3. A data unit may be, for example, a 64-bit data that ranges from the 0th to 63rd bits. In the example illustrated in FIG. 4, the data unit of transmission data transmitted by data bus #00 is indicated by DATA0. In addition, the data unit of transmission data transmitted by data bus #01 is indicated by DATA1; the data unit of transmission data transmitted by data bus #02 is indicated by DATA2; and the data unit of transmission data transmitted by data bus #03 is indicated by DATA3.

In the example of FIG. 4, for example, data units indicated by D00 to D03 and C00 to C03 are transmitted by the data bus #00, and data units indicated by D10 to D13 and C10 to C13 are transmitted by the data bus #01.

The arithmetic/reconfiguration selecting signal is a signal indicating whether the corresponding transmission data is normal calculation data (first data) or reconfiguration data (second data). In the example illustrated in FIG. 4, Config0 to Config3 correspond to the arithmetic/reconfiguration selecting signals. The transmission data in which the operation/reconfiguration selecting signal (Coinfig0 to Config3) is set to 0 is normal calculation data (see the reference signs P1 and P3), and the transmission data in which the operation/reconfiguration selecting signal is set to 1 is reconfiguration data (see the reference sign P2).

That is, 0 in Config0 to Config3, which represents the value 0 set in the operation/reconfiguration selecting signal, is an example of identification information that indicates the corresponding transmission data is normal calculation data. In contrast, 1 in Config0 to Config3, which represents the value 1 set in the operation/reconfiguration selecting signal, is an example of identification information that indicates the corresponding transmission data is reconfiguration data.

The VLD signal is a signal indicating whether or not the corresponding transmission data is valid data. The valid data may be data that the PE 3 has to receive. For example, a PE 3 acquires and the processes the data unit included in transmission data in which the VLD signal is set to 1.

In the example illustrated in FIG. 4, the VLD signal of the transmission data transmitted by the data bus #00 is indicated by VLD0. In addition, the VLD signal of the transmission data transmitted by the data bus #01 is indicated by VLD1; the VLD signal of the transmission data transmitted by the data bus #02 is indicated by VLD2; and the VLD signal of the transmission data transmitted by the data bus #03 is indicated by VLD3.

In the example illustrated in FIG. 4, the VLD signal of the transmission data including a data unit is set to 1. Transmission data (see the hatched squares with oblique lines in FIG. 4) in which the VLD signal is set to 1 and the operation/reconfiguration selecting signal (Config0 to Config3) is set to 0 is processed as normal calculation data in the corresponding PEs 3. In addition, transmission data (see the hatched squares with grid patterns in FIG. 4) in which the VLD signal is set to 1 and the operation/reconfiguration selecting signal (Config0 to Config3) is set to 1 is processed as reconfiguration data in the corresponding PEs 3.

In the example illustrated in FIG. 4, each of the four data buses 4 needs four cycles to transmit reconfiguration data (see reference sign P2). Thus, strictly speaking, the sum ((4+α) cycles) of this four cycles and the time required for synchronization between data buses 4 is the time the reconfiguration of a PE 3 takes.

FIG. 5 is a diagram illustrating the configuration of the reception processor 5a provided to each PE 3 of the accelerator 1 of the example of the first embodiment.

The reception processor 5a includes a counter 51 and a determiner 52 as illustrated in FIG. 5.

As described above, in the accelerator 1 of the first embodiment, transmission data is transmitted in the time-slot scheme, and a cycle and a PE 3 are associated with each other.

The counter 51 counts the number of cycles. The determiner 52 detects a particular cycle associated with the PE 3 (which may be referred to as the own PE 3) on which the same determiner 52 is mounted, and captures transmission data from the data bus 4 at this particular cycle.

The determiner 52 may synchronize with a timing adjusting block (not illustrated) that adjusts the timing of inputting transmission data into the data bus 4 and thereby identify the subsequent reception timings (cycles) at which transmission data to be transmitted to the own PE 3 is received.

In the example of FIG. 2 described above, for example, the reception processor 5a of the PE #1 can acquire two pieces of transmission data destined for the own PE 3 (PE #1) by capturing transmission data from the data bus 4 at the cycle #1.

The reception processor 5a of each of the multiple PES 3 selectively receives the normal calculating data (first data) and the reconfiguration data (second data) destined for the PE 3 (own PE 3, a PE 3 mounting thereon the reception processor 5a) by extracting the transmission data from the data bus 4 at the cycle associated with the own PE 3.

### Operation:

In the accelerator 1 of the first embodiment configured as the above, the controller 7 receives a command and the like transmitted from the host computer and performs a process. The controller 7 transmits normal calculation data to a PE 3 via the data bus 4 to cause the PE 3 to perform an arithmetic operation. Alternatively, the controller 7 transmits reconfiguration data to a PE 3 via the data bus 4 to change (modify) the circuitry of the PE 3.

Through the data bus 4, the transmission data is transmitted in a time-slot scheme. The transmission data is collected for each PE 3 and the transmission data destined for the same PE 3 are transmitted in the same cycle.

In the PE 3, the reception processor 5a counts the cycles using the counter 51 and inputs the count into the determiner 52. The determiner 52 captures transmission data from the data bus 4 in a cycle associated with the own PE 3. As a result, the PE 3 receives transmission data destined for itself, executes an arithmetic operation using the received normal calculation data or otherwise reconfigures its circuitry using the received reconfiguration data.

### Effect

As described above, the accelerator 1 according to an example of the first embodiment transmits reconfiguration data for a PE 3 through the data bus 4, which can eliminate the requirement for a dedicated path (configuration path) for transmitting the reconfiguration data. This can reduce the cost for wiring and also reduce the mounting area.

In addition, the data bus 4 transmits multiple pieces of transmission data destined for the multiple PEs 3 in a time-slot scheme, and transmission data destined for the same destination (OE 3) is collectively transmitted at one cycle. This can shorten the time for transmission as compared with a typical method, in which each individual transmission data is transmitted via P2P (Peer-to-Peer) communication. Furthermore, the data bus 4 can be used efficiently, and data transmission efficiency can be enhanced. In addition, this can also enhance the performance of accelerator 1.

Such shortening time for transmitting the reconfiguration data can shorten the time for reconfiguration of each PE 3.

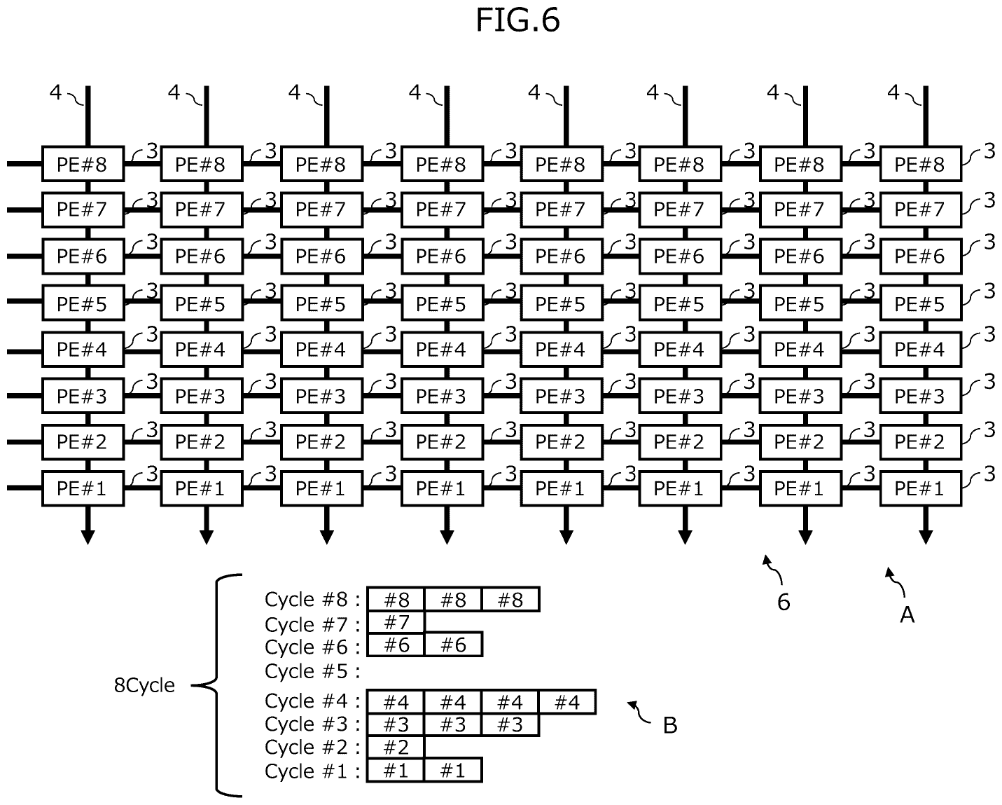

FIG. 6 is a diagram illustrating an effect brought by a method for transmitting the transmission data in the accelerator 1 of the example of the first embodiment.

In FIG. 6, the reference sign A indicates an example of the configuration of the PE group 6, and the reference sign B indicates a method of transmitting the transmission data by the accelerator 1 of the first embodiment.

For example, in a typical method, a systolic array having 64 PEs 3 formed into an 8×8 matrix configuration as indicated by reference sign A takes one cycle to transmit transmission data to one PE. This means that a systolic array having 64 PEs takes 64 cycles to transmit transmission data to all the PEs.

In contrast to the above, as indicated by the reference sign B in FIG. 6, the accelerator 1 of the first embodiment can transmit transmission data to all the PEs in eight cycles, so that the time for transmitting the transmission data can be shortened.

### Description of Second Embodiment

### Configuration:

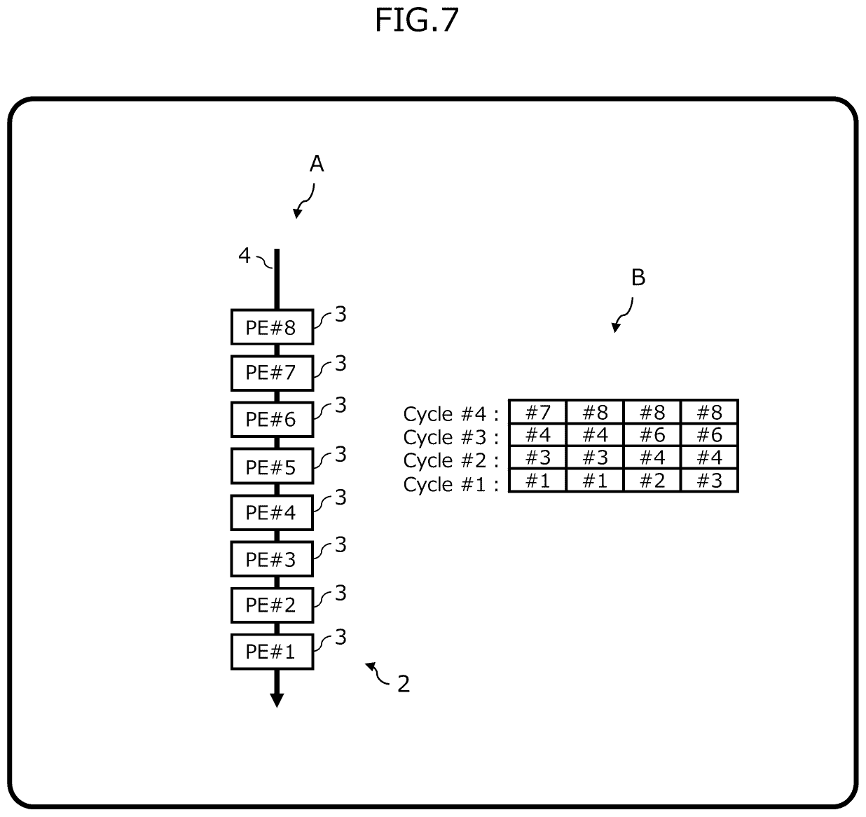

FIG. 7 is a diagram illustrating a method for transmitting the transmission data in the accelerator 1 of the example of the second embodiment.

Also in the second embodiment, the accelerator 1 is an arithmetic operator having a systolic array configuration like the first embodiment. A PE 3 is an example of an arithmetic element configured as a programmable circuit capable of programming a logical function. The circuitry of the PE 3 is set on the basis of reconfiguration data.

The accelerator 1 of the second embodiment may also have the same configuration as the accelerator 1 of the first embodiment illustrated in FIG. 1.

In FIG. 7, the reference sign A indicates multiple PES 3 constituting one of multiple columns included in the PE group 6. Also FIG. 7 illustrates, likewise in FIG. 2, an example that transmits transmission data to eight PEs 3 of PE #1 to PE #8 connected to the bus 4. In the expressions of PE #1 to #8, #1 to #8 are identification information that specifies the respective PEs 3. This identification information may be referred to as PE numbers. In addition, the reference sign B illustrates an transmission data transmitted to the data bus 4 indicated by reference sign A.

In the accelerator 1 of the second embodiment, transmission data for multiple PEs 3 on the same data bus 4 are merged into one data aggregation, as indicated by the reference sign B. FIG. 7 illustrates an example in which one data aggregation is formed of multiple pieces of transmission data destined for eight PEs 3.

The example illustrated by the reference sign B in FIG. 7 illustrates a data aggregation in which multiple pieces of transmission data transmitted to the PEs #1 to PE #8 are merged (grouped) into one block. This data aggregation arranges therein the multiple pieces of transmission data such that the leading data is located at the left bottom and the last data is located at the right top, which means that the transmission data arranged in ascending order of PE numbers rightward in the row direction and upward in the column direction. In this case, transmission data having a short requisite length are collected. If a PE 3 to which data transmission is not required is present, addition of transmission data destined for the PE 3 to the data aggregation is skipped and the transmission data destined for the next PE 3 is incorporated into the data aggregation. In the example illustrated in FIG. 7, transmission data destined for the PE #5 is not present.

In the accelerator 1 of the second embodiment, transmission data destined for multiple PEs 3 (arithmetic elements) on the same data bus 4 are merged into a single data aggregation, which is transmitted through the data bus 4.

In transmitting the data aggregation illustrated in the reference sign B of FIG. 7 through the data bus 4, transmission data in a certain row in a certain row in the data aggregation indicated by the reference sign B may be transmitted in a single (transmission) cycle. For example, in the cycle #1, two pieces of transmission data for the PE #1, one piece of transmission data for the PE #2, and one piece of transmission data for the PE #3 are transmitted. In the following cycle #2, two pieces of transmission data for the PE #3 and two pieces of transmission data for the PE #4 are transmitted. Two pieces of transmission data for the PE #4 and two pieces of transmission data for the PE #6 are transmitted in the cycle #3, and one piece of transmission data for the PE #7 and three pieces of transmission data for the PE #8 are transmitted in the cycle #4.

Consequently, when the data aggregation illustrated in reference sign B of FIG. 7 is transmitted through the data bus 4, the bus occupancy period is four cycles.

In the accelerator 1 according to the second embodiment, the transmission procedure (e.g., destination confirmation or negotiation) may be performed once before the transmission of the data aggregation, and does not have to be performed at every cycle. Therefore, in the example illustrated in FIG. 7, 16 transmission data to the PE #1 to the PE #8 are transmitted in a single transmission procedure.

The same process is carried out for each column. In addition, the same process is carried out for each of multiple rows included in the PE group 6.

Also in the accelerator 1 of the second embodiment, transmission data addressed to the multiple PEs 3 arranged on the data bus 4 are transmitted through the same data bus 4. As a result, multiple pieces of transmission data destined for different PEs 3 are transmitted to one data bus 4. Like the first embodiment, this control may be performed by, for example, the controller 7, or may be performed by another non-illustrated controller, and various modifications can be suggested.

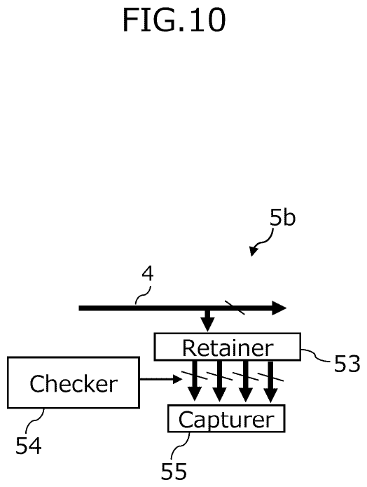

For this purpose, in the accelerator 1 of the second embodiment, each PE 3 is provided with a reception processor 5ba (see FIG. 10) that receives transmission data that the same PE 3 is to process from the data bus 4.

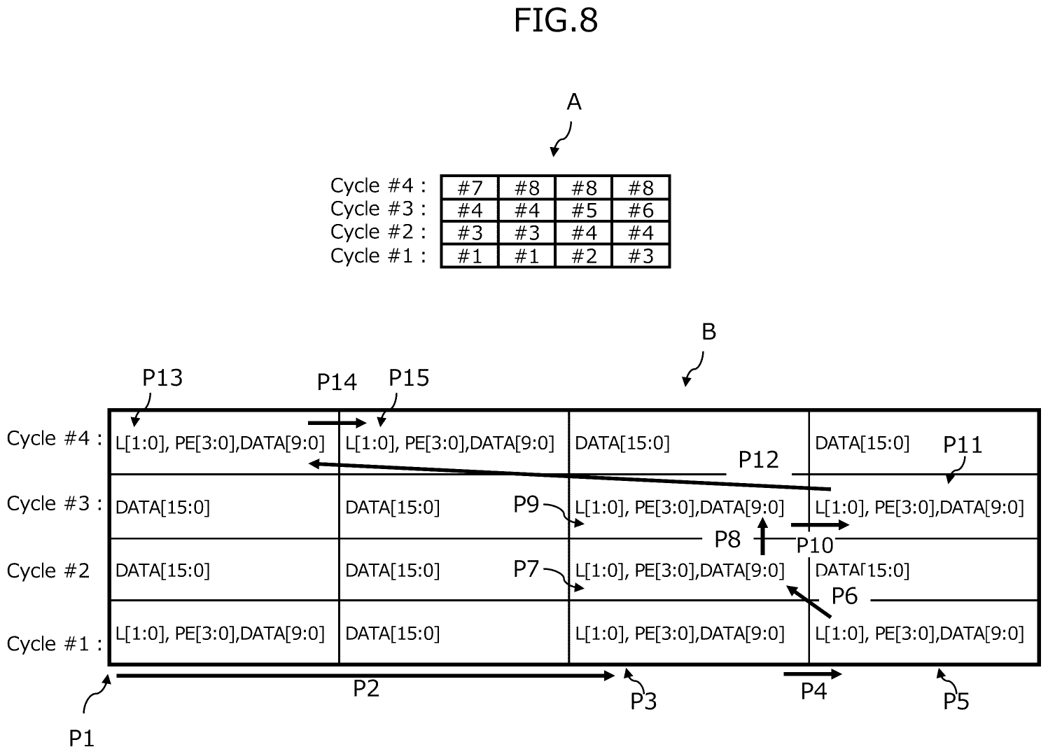

FIG. 8 is a diagram illustrating a data configuration that achieves a data aggregation forwarded by the accelerator 1 of the example of the second embodiment.

In FIG. 8, the reference sign A indicates a data aggregation of transmission data transmitted to the PE #1 through the PE #8. As described above, in the data aggregation indicated by the reference sign A, multiple pieces of transmission data are arranged in ascending order of PE numbers starting from the left bottom, which causes the transmission data destined for the same destination (PE 3) are successively arranged. An aggregation of successive transmission data destined for the same destination (PE 3) may be referred to as a PE-basis transmission data aggregation. The number of pieces of transmission data included in a PE-basis transmission data aggregation may be referred to as the number of slots (slot number). In the accelerator 1 of the second embodiment, such a data aggregation is transmitted over multiple cycles (four cycles in the example illustrated in FIG. 8). In FIG. 8, the reference sign B illustrates a data configuration that achieves the data aggregation indicated by the reference sign A.

In the accelerator 1 of the second embodiment, multiple segments are generated by partitioning the data bus 4 by a predetermined fixed length. In the data configuration illustrated by the reference sign B in FIG. 8, each square corresponds to one segment, and information of the transmission data is set in these segments.

In the data configuration illustrated by the reference sign B, information of the PE-basis transmission data aggregations is registered. In the data configuration illustrated by the reference sign B, each segment corresponds to one piece of the transmission data.

If a PE-basis transmission data aggregation includes multiple pieces of transmission data, a segment at the leading position among the multiple segments associated with a single PE-basis transmission data aggregation may be referred to as the leading segment.

The information of each PE-basis transmission data aggregation includes a data length, PE specifying information, and a data unit. The data length represents the length of data of a PE-basis transmission data aggregation. The data length is an example of data length information. The data length may be represented in a slot number. In the example illustrated in FIG. 8, L[1:0] indicates the data length, and the slot number is represented by a two-bit value.

For example, in the data aggregation indicated by the reference sign A in FIG. 8, since the PE-basis transmission data aggregation to be transmitted to the PE #1 includes two pieces of (two-slot) transmission data, the value 1, which corresponds to two, is set in the value of L[1:0].

The PE specifying information is information for specifying a PE 3, and is an example of transmission destination specifying information. In the example illustrated in FIG. 8, PE[3:0] indicates the PE specifying information, and the PE number (the number of the PE number) is represented by a 4-bit value.

For example, in the data aggregation indicated by the reference sign A in FIG. 8, since the PE number of the PE-basis transmission data aggregation is 1, the value 0, which corresponds to 1, is set in the value of PE[3:0]. The data unit is normal calculation data and reconfiguration data.

If a PE-basis transmission data aggregation includes multiple pieces of transmission data, the data length and the PE specifying information among the data length, the PE specifying information, and the data unit are stored in the leading segment among multiple segments corresponding the PE-basis transmission data aggregation. In contrast, the data unit is stored in the respective segments.

In the example illustrated in FIG. 8, DATA[9:0] indicates a data unit stored in the leading segment, and also indicates that the data unit is stored in a 10-bit value. In the segments except for the lading segment, DATA[15:0] indicates the data unit and means that the data unit is stored in a 16-bit value.

In the example illustrated in FIG. 8, the lower left corner in the data configuration formed into a block in the drawing corresponds to the leading position of the data configuration, and the leading segment of the PE-basis transmission data aggregation of the PE #1 is located at the leading position (see reference sign P1 in FIG. 8).

Referring to the data length L[1:0] stored in this leading segment and skipping the number (two in this example) of segments corresponding to this data length (see the reference sign P2 in FIG. 8) reaches the leading segment of the PE-basis transmission data aggregation of the PE #2 subsequent to the PE #1 (see the reference sign P3 in FIG. 8).?

In addition, in the PE-basis transmission data aggregation of the PE #2, referring to the data length L[1:0] stored in the leading segment and skipping the number (one in this example) of segments corresponding to this data length (see the reference sign P4 in FIG. 8) reaches the leading segment of the PE-basis transmission data aggregation of the PE #3 subsequent to the PE #2 (see the reference sign P5 in FIG. 8).

In addition, in the PE-basis transmission data aggregation of the PE #3, referring to the data length L[1:0] stored in the leading segment and skipping the number (three in this example) of segments corresponding to this data length (see the reference sign P6 in FIG. 8) reaches the leading segment of the PE-basis transmission data aggregation of the PE #4 subsequent to the PE #3 (see the reference sign P7 in FIG. 8).

In addition, in the PE-basis transmission data aggregation of the PE #4, referring to the data length L[1:0] stored in the leading segment and skipping the number (four in this example) of segments corresponding to this data length (see the reference sign P8 in FIG. 8) reaches the leading segment of the PE-basis transmission data aggregation of the PE #5 subsequent to the PE #4 (see the reference sign P9 in FIG. 8).

In addition, in the PE-basis transmission data aggregation of the PE #5, referring to the data length L[1:0] stored in the leading segment and skipping the number (one in this example) of segments corresponding to this data length (see the reference sign P10 in FIG. 8) reaches the leading segment of the PE-basis transmission data aggregation of the PE #6 subsequent to the PE #5 (see the reference sign P11 in FIG. 8).

In addition, in the PE-basis transmission data aggregation of the PE #6, referring to the data length L[1:0] stored in the leading segment and skipping the number (one in this example) of segments corresponding to this data length (see the reference sign P12 in FIG. 8) reaches the leading segment of the PE-basis transmission data aggregation of the PE #7 subsequent to the PE #6 (see the reference sign P13 in FIG. 8).

In the PE-basis transmission data aggregation of the PE #7, referring to the data length L[1:0] stored in the leading segment and skipping the number (one in this example) of segments corresponding to this data length (see the reference sign P14 in FIG. 8) reaches the leading segment of the PE-basis transmission data aggregation of the PE #8 subsequent to the PE #7 (see the reference sign P15 in FIG. 8).

In the data configuration configured as the above, it is possible to extract the PE-basis transmission data aggregations from the data aggregation formed into a block by referring to the respective leading segments.

The reception processor 5b of each PE 3 selectively receives the normal calculation data (first data) and the reconstruction data (second data) that are destined for the own PE 3 from the data aggregation with reference to the data length (data length information) and the PE specifying information (transmission destination specifying information).

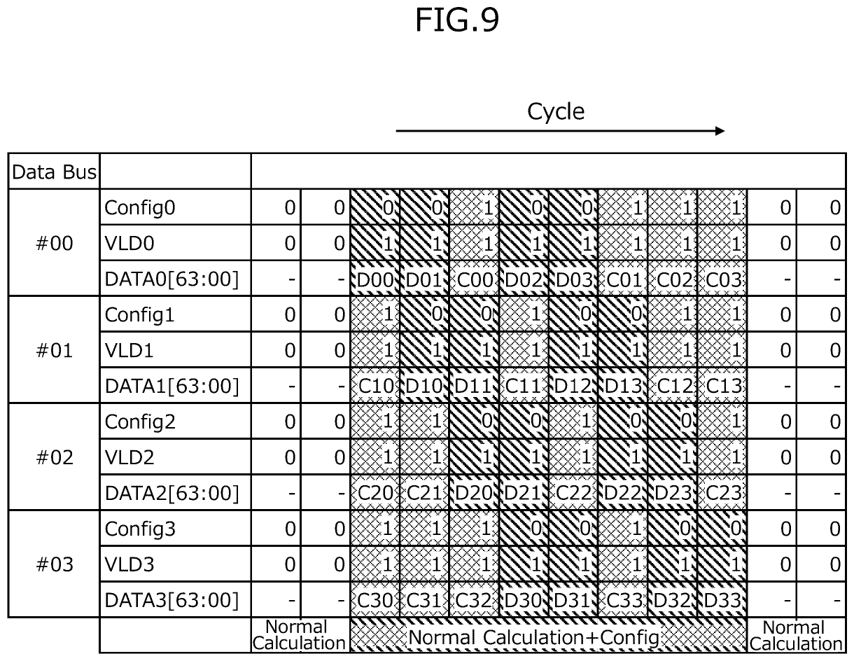

FIG. 9 is a diagram illustrating transmitting of the transmission data through multiple data buses 4 in the accelerator 1 of the example of the second embodiment.

FIG. 9 illustrates multiple pieces of transmission data transmitted in four respective neighboring data buses #00 to #03 in the accelerator 1. In addition, in FIG. 9, the right direction of the drawing indicates the direction of passage of time and one square corresponds to one cycle (transmitting cycle). In FIG. 9, multiple transmission data arranged vertically in the drawing are transmitted in the same cycle.

The PEs 3 on the data buses #00 to #03 use the data unit of the normal calculation data for an arithmetic operation. At each cycle, the result of the arithmetic operation of each PE 3 is passed to a PE 3 on a neighboring data bus 4, which sequentially executes a process using the result. For example, the result of an arithmetic operation performed by a particular PE 3 on the data bus #00 is passed to neighboring PE 3 on the data bus #01 neighboring this particular PE 3 in the next cycle and consequently processed.

Like the first embodiment, also in the accelerator 1 of the second embodiment, the transmission data includes an arithmetic/reconfiguration selecting signal, a VLD signal, and a data unit.

In the example illustrated in FIG. 9, the data unit of transmission data transmitted by the data bus #00 is indicated by DATA0. In addition, the data unit of the transmission data transmitted by the data bus #01 is indicated by DATA1; the data unit of the transmission data transmitted by the data bus #02 is indicated by DATA2; and the data unit of the transmission data transmitted by the data bus #03 is indicated by DATA3.

In the example of FIG. 9, for example, data units indicated by D00 to D03 and C00 to C03 are transmitted by the data bus #00, and data units indicated by D10 to D13 and C10 to C13 are transmitted by the data bus #01.

In the example illustrated in FIG. 4, Config0 to Config3 correspond to the arithmetic/reconfiguration selecting signals. Transmission data in which Config0 to Config3 are set to 0 are normal arithmetic data, and transmission data in which the arithmetic/reconfiguration selecting signal is set to one are reconfiguration data.

In example illustrated in FIG. 9, in the data buses #00 to #03, transmission of normal calculation data indicated by hatching with oblique lines and transmission of reconfiguration data indicated by hatching with grid patterns are mixed.

As described above, in the accelerator 1 of the second embodiment, since the leading segment has the PE specifying information in each PE-basis transmission data aggregation of the data aggregation, the destination PE 3 successfully receives the reconfiguration data that the same PE 3 has to receive even if the reconfiguration data is discontinuously transmitted (i.e., for each PE 3).

That is, by transmitting data aggregations in which normal calculation data and reconfiguration data that are destined for multiple PEs 3 on the data buses 4, it is possible to transmit the reconfiguration data to the respective multiple PEs 3.

FIG. 10 is a diagram illustrating the configuration of the reception processor 5b provided to each PE 3 of the accelerator 1 of the example of the second embodiment.

The reception processor 5b includes a retainer 53, a checker 54 and a capturer 55, as illustrated in FIG. 10.

As described above, the accelerator 1 of the second embodiment transmits transmission data destined for multiple PEs 3 on the same data bus 4 with a single data aggregation, and the leading segments of multiple PE-basis transmission data aggregations included in the data aggregation each include the data length, the PE specifying information, and the data unit.

The retainer 53 temporarily stores a data aggregation transmitted on the data bus 4. The retainer 53 may be, for example, a memory. The retainer 53 may store a single data aggregation by receiving partitioned data aggregation transmitted over multiple cycles (four in the example illustrated in FIG. 8) and combining the partitioned data received therein.

The capturer 55 extracts to-be-transmitted data from the data aggregation stored in the retainer 53 in obedience to the instruction of the checker 54 to be described below. The PE 3 carries out an arithmetic operation or reconfiguration of its circuitry, using the data extracted by the capturer 55.

The checker 54 refers to the PE specifying information of the respective leading segments of the data aggregation stored in the retainer 53, and determines whether the PE-basis transmission data aggregation including the leading segment is associated with the own PE 3.

For example, the checker 54 first refers to the PE specifying information in the leading segment located at the leading position of the data aggregation stored in the retainer 53, and determines whether the PE-basis transmission data aggregation is associated with the own PE 3. If the PE-basis transmission data aggregation is associated with the own PE 3, the checker 54 notifies the capturer 55 of for example, the storing position of the to-be-transmitted data included in the same PE-basis transmission data aggregation and causes the capturer 55 to capture the to-be-transmitted data into the own PE 3.

In contrast, if the PE-basis transmission data aggregation is not associated with the own PE 3, the checker 54 refers to the data length L[1:0] of the leading segment, skips the segment number corresponding to this data length, and accesses the leading segment of the ensuing PE-basis transmission data aggregation.

The checker 54 refers to the PE specifying information in the leading segment and determines whether the PE-basis transmission data aggregation is associated with the own PE 3. If the PE-basis transmission data aggregation is not associated with the own PE 3, the checker 54 refers to the data length L[1:0] of the leading segment, skips the segment number corresponding to this data length, and accesses the leading segment of the ensuing PE-basis transmission data aggregation.

The checker 54 refers to the PE specifying information in the leading segment of the ensuing PE-basis transmission data aggregation accessing as the above manner, and determines whether the PE-basis transmission data aggregation is associated with the own PE 3. If determining that the PE-basis transmission data aggregation is associated with the own PE 3, the checker 54 notifies the capturer 55 of the result of the determination. At this time, the checker 54 may notify the capturer 55 of the position of the data unit included in the PE-basis transmission data aggregation.

In obedience to the instruction from the checker 55, the capturer 54 extracts the data unit of the PE-basis transmission data aggregation associated with the own PE 3. Hereinafter, by repeating the same process, the reception processor 5b obtains the transmission data addressed to the own PE 3 from the data bus 4. The PE 3 carries out an arithmetic operation or reconfiguration of the circuitry, using the data extracted by the capturer 55.

### Operation:

In the accelerator 1 of the second embodiment configured as the above, the controller 7 receives a command and the like transmitted from the host computer and performs a process. The controller 7 transmits normal calculation data to a PE 3 via the data bus 4 to cause the PE 3 to perform an arithmetic operation. Alternatively, the controller 7 transmits reconfiguration data to a PE 3 via the data bus 4 to change (modify) the circuitry of the PE 3.

In the accelerator 1 of the second embodiment, transmission data for multiple PEs 3 on the same data bus 4 are formed into a single data aggregation. The data aggregation formed as the above is partitioned for each cycle and transmitted over the data bus 4. At this time, it is desirable to partition the data aggregation to match the band of the data bus 4. For example, by partitioning the data aggregation to match the band of the data bus 4, the data bus 4 can be efficiently used.

In the reception processor 5b of each PE 3, the retainer 53 receives the partitioned data aggregation transmitted over multiple cycles, and stores the received data as a single data aggregation.

In addition, the checker 54 determines, on the basis of the data length and the PE specifying information in the leading segment of each PE-basis transmission data aggregation in the data aggregation that the retainer 53 stores, whether the PE-basis transmission data aggregation is associated with the own PE 3.

Then, the capturer 55 extracts the data unit included in a PE-basis transmission data aggregation that the checker 54 determines to be associated with the own PE 3. The PE 3 carries out an arithmetic operation or reconfiguration of the circuitry, using the data extracted by the capturer 55.

### Effect

Likewise the first embodiment, also the accelerator 1 according to an example of the second embodiment transmits reconfiguration data through the data bus 4, which can eliminate the requirement for a dedicated path (configuration path) for transmitting the reconfiguration data. This can reduce the cost for wiring and also reduce the mounting area.

In addition, transmission data for multiple PEs 3 on the same data bus 4 are formed into a single data aggregation. The data aggregation formed as the above is partitioned for each cycle and transmitted through the data bus 4.

In transmitting of the data aggregation, data bus 4 can be efficiently used by partitioning the data aggregation to match the band of the data bus 4, so that the transmission efficiency of data can be enhanced. In addition, this can enhance the performance of accelerator 1.

The data aggregation includes multiple PE-basis transmission data aggregations, and the leading segments of the respective PE-basis transmission data aggregations each include, serving as the information of the PE-basis transmission data aggregation, the data length, the PE specifying information, and the data unit.

In the reception processor 5b of each PE 3, the checker 54 determines, on the basis of the data length and the PE specifying information in the leading segment of each PE-basis transmission data aggregation in the data aggregation captured from the data bus 4, whether the PE-basis transmission data aggregation is associated with the own PE 3. Accordingly, each PE 3 can obtain a data unit associated with the own PE 3 from the data aggregation in which the transmission data destined for multiple PEs 3 are merged into a single data.

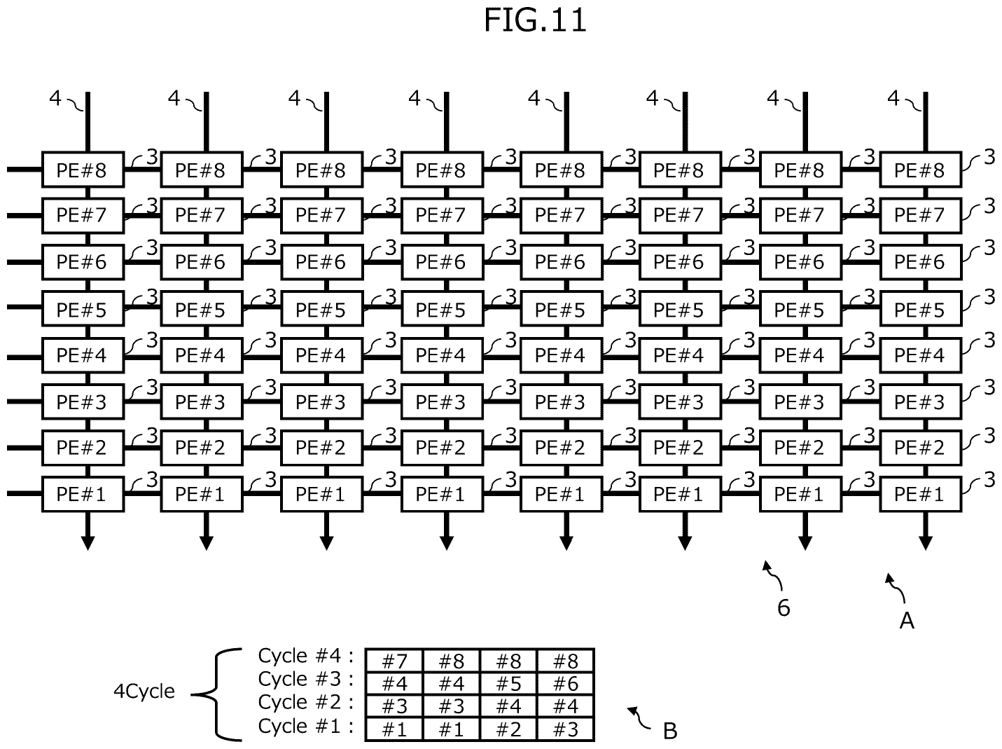

FIG. 11 is a diagram illustrating an effect brought by a method for transmitting the transmission data in the accelerator 1 of the example of the second embodiment.

In FIG. 11, the reference sign A indicates an example of the configuration of the PE group 6, and the reference sign B indicates a method of transmitting the transmission data by the accelerator 1 of the second embodiment.

For example, in a typical method, a systolic array having 64 PEs 3 formed into an 8×8 matrix configuration as indicated by reference sign A takes one cycle to transmit transmission data to one PE 3. This means that a systolic array having 64 PEs 3 takes 64 cycles to transmit transmission data to all the PEs 3.

In contrast to the above, as indicated by the reference sign B in FIG. 11, the accelerator 1 of the second embodiment can transmit transmission data to all the PEs 3 in four cycles, so that the time for transmitting the transmission data can be shortened.

In addition, such shortening time for transmitting the reconfiguration data can shorten the time for reconfiguration of the PEs 3.

### Miscellaneous

The respective configuration and the respective process of the above embodiment can be selected, omitted, and appropriately combined according to the requirement.

The disclosed technique is by no means be limited to the above embodiments, and various modification can be suggested without departing from the scope of the embodiments.

The present embodiments can be achieved or produced by those ordinary skilled in the art referring to the above disclosure.

According to the embodiments, the time for reconfiguration can be shortened.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An arithmetic operator comprising:
a plurality of arithmetic elements each serving as a programmable circuit capable of programming a logical function; and
a data bus that connects two or more of the plurality of arithmetic elements and that transmits transmission data, wherein
the transmission data includes first data to be used in any one of the two or more arithmetic elements and second data to be used to reconfigure a logical function of any one of the two or more arithmetic elements,
the transmission data destined for each of the two or more arithmetic elements on the same data bus is collectively transmitted on the same data bus at a cycle different with each of the two or more arithmetic elements, and
each of the two or more arithmetic elements comprises a reception processor that selectively receives the first data and the second data destined for own arithmetic element by extracting the transmission data destined for the own arithmetic element at a cycle associated with the own arithmetic element from the data bus.

2. The arithmetic operator according to claim 1, wherein
the first data includes identification information of the first data, and
the second data includes identification information of the second data.

3. An arithmetic operator comprising:
a plurality of arithmetic elements each serving as a programmable circuit capable of programming a logical function; and
a data bus that connects two or more of the plurality of arithmetic elements and that transmits transmission data, wherein
the transmission data includes first data to be used in any one of the two or more arithmetic elements and second data to be used to reconfigure a logical function of any one of the two or more arithmetic elements,
the transmission data destined for the two or more of arithmetic elements on the same data bus are merged to form a data aggregation and the data aggregation is transmitted through the data bus,
an aggregation of transmission data destined for each of the two or more arithmetic elements among the data aggregation includes data length information and destination specifying information, and
each of the two or more arithmetic elements comprises a reception processor that selectively receives the first data and the second data destined for own arithmetic element with reference to the data length information and the destination specifying information.

4. The arithmetic operator according to claim 3, wherein
the first data includes identification information of the first data, and
the second data includes identification information of the second data.
